(19) United States
(12) Patent Application Publication
(10) Pub. No.: US 2024/0196942 A1
(43) Pub. Date: Jun. 20, 2024

(54) AQUAFABA PRODUCTS AND METHODS

(71) Applicant: ALTERNATIVE FOODS LONDON LTD., London (GB)

(72) Inventors: James Kingham, London (GB); Mike Turner, London (GB)

(73) Assignee: ALTERNATIVE FOODS LONDON LTD., London (GB)

(21) Appl. No.: 18/034,711

(22) PCT Filed: Sep. 1, 2001
(86) PCT No.: PCT/EP2021/074188

§ 371 Date: Jul. 10, 2023

(30) Foreign Application Priority Data
Sep. 1, 2020 (GB) 2013709.7

(51) Int. Cl. A23L 11/00; A23L 15/00

(52) U.S. Cl. CPC A23L 11/00; A23L 15/35

(57) ABSTRACT

Packaged aquafaba comprising polysaccharides and protein, wherein the ratio of polysaccharides: protein is 40:60 to 60:40, and wherein the polysaccharides comprise at least 40% arabinose, galactose or a combination thereof.

### FIELD

The present disclosure generally relates to aquafaba products and methods of making and using aquafaba. More particularly, the present disclosure relates to aquafaba and methods of manufacturing aquafaba.

### BACKGROUND

Aquafaba is legume brine, most commonly, but not limited to, chickpea brine.

Aquafaba has been used to replace egg, particularly, egg whites in sweet and savoury recipes. Aquafaba contains starches, proteins, and other soluble plant solids that are released from legumes to water during the cooking process.

There has been a dramatic increase in interest and uptake of vegan diet across the world. Recent data show 70% of the world's population are eating less meat, and since 2010 the number of new vegan products available has increased by over 250% 1. As of 5 years ago, the term “plant-based” had a popularity score of 13 out of 100 as analysed by Google searches. However, as of last year (2019), this number increased to 100 out of 100. Furthermore, food allergies are on the increase, including allergy to eggs, further increasing the need to find a reliable alternative to eggs in foodstuffs.

In many cooking and baking recipes, eggs act as important ingredient due to their binding qualities and air-retaining capacity. Whilst plant-derived egg alternatives are available (chia seeds, flax seeds, vegan yoghurts, potato starch or maize starch etc.) their capacity to replicate the properties of traditional eggs is limited. Often, the end result (particularly in baking) is inferior in taste, texture and appearance to similar recipes using eggs. None of these alternatives can provide both binding and air-retention qualities.

The most common source for obtaining aquafaba is from a can of pre-cooked chickpeas. However, such products are inconsistent in their composition, from a chemical composition perspective and the additivities they contain, including salts and sugars, which results in inconsistent functionality and foaming capability batch to batch, brand to brand and legume to legume. Experience shows that sometimes the aquafaba liquid functions adequately as an egg substitute and sometimes it does not function well.

Aquafaba can also be made at home by boiling chickpeas on a stove. However, due to the complex chemical composition of aquafaba and the challenge in replicating it consistently, the results are inconsistent and unreliable. Published literature (Aquafaba: Sweet and Savoury Vegan Recipes Made Egg-Free with the Magic of Bean Water, Zsu Dever, 2016) explains that such aquafaba obtained by such methods is not capable of producing a good foam every time. Alternative aquafaba currently available is unreliable, as it produces inconsistent and sub optimal results.

Therefore, there is a clear and serious need for a plant-based egg substitute which is capable of replicating the chemical properties of eggs in cooking and baking. Not only is this important on an individual, home-baking scale, but on a large, industrial scale to meet the increasing demand of plant-based consumerism which will have a positive environmental impact; ton for ton, aquafaba reduces CO2 emissions by 28 tons vs. whole egg.

Accordingly, it is desirable to develop a consistent, stable and functionally effective aquafaba as an egg substitute in various cooking applications and the methods of obtaining such aquafaba in a repeatable and reliable way. In addition, it is desirable to provide consumers with reliable aquafaba more conveniently.

The inventors of the present invention have discovered that aquafaba comprising a particular ratio of protein to polysaccharides produces a superior, plant-based alternative to traditional hens' eggs, and other plant-based alternatives currently available. Due to the superior whipping capacity of the aquafaba and its ability to retain a stiff, stable foam, emulsify and bind, the claimed aquafaba provides a plant-based alternative with all the desirable characteristics of traditional eggs.

Furthermore, other desirable features and characteristics of the present invention will become apparent from the subsequent detailed description of the invention and the appended claims, taken in conjunction with the accompanying drawings and the background of the invention.

### SUMMARY

The invention provides packaged aquafaba comprising polysaccharides and protein, wherein the ratio of polysaccharides:protein is 40:60 to 60:40, and wherein the polysaccharides comprise at least 40% arabinogalactans. Arabinogalactans are arabinose, galactose or a combination thereof. The polysaccharides may comprise no more than 50% glucose, no more than 40% glucose or no more than 30% glucose.

The protein concentration may be from 3 g/L to 17 g/L, such as from 3.4 g/L to 16.2 g/L. The protein concentration may be from 12.5 g/L to 30 g/L.

The polysaccharide concentration may be from 1 g/L to 12.5 g/L, such as from 1.3 g/L to 11.9 g/L. The polysaccharide concentration may be from 12.5 g/L to 30 g/L.

The aquafaba may comprise at least 20 g/L total solids. The aquafaba may comprise at least 6% total solids.

The aquafaba may have a pH of less than pH 6.

The aquafaba may be made from chickpeas, butter beans, haricot beans, black beans, red kidney beans, cannellini beans, navy beans, mung beans, pinto beans and/or combinations thereof. Preferably, the aquafaba is made from chickpeas.

Also provided by the invention is a method of producing aquafaba of any preceding claim comprising the steps of:
a) heating legumes in water increasing the temperature to at least 95° C., wherein the legumes have been soaked and drained;
b) cooking the legumes at at least 95° C. for at least 1 hr 30 minutes, maintaining a temperature between 92° C. and 98° C.;
c) separating the legumes from the water within 30 mins of cooking to obtain aquafaba.

Also provided by the invention is a method of producing aquafaba of any preceding claim comprising the steps of:
a) heating legumes in water increasing the temperature to above 100° C., wherein the legumes have been soaked and drained;
b) pressure cooking the legumes at at least 102° C. for at least 45 minutes, maintaining a temperature between 101° C. and 110° C.;
c) separating the legumes from the water within 30 mins of cooking to obtain aquafaba

Steps a) and b) may be carried out at 100 to 6000 millibar, 150 to 4000 millibar, 150 to 3000 millibar or 150 to 2500 millibar.

The method may also include one or more of soaking the legumes in water for at least 8 hours prior to step a); removing the water from the legumes to obtain drained legumes; rinsing the legumes in clean water prior to step a); removing excess scum or foam producing during cooking prior to step c); acidifying the water in which the legumes are heated; packaging the aquafaba obtained from step c); and retorting the packaged aquafaba.

The method may comprise retorting or aseptically filling the packaged aquafaba.

Step b) may be carried out for less than or equal to 240 minutes, 190 minutes, 150 minutes, 120 minutes, 105 minutes, 90 minutes, 75 minutes, 70 minutes, 65 minutes, 60 minutes, 55 minutes, 50 minutes, 45 minutes, 40 minutes, 35 minutes or 30 minutes.

The legumes may be selected from chickpeas, butter beans, haricot beans, black beans, red kidney beans, cannellini beans, navy beans, mung beans, pinto beans and/or combinations thereof.

The legumes are preferably chick peas.

The legumes are preferably soaked and drained prior to heating in water. The legumes are preferably soaked in cold water prior to heating in water. The ratio of legumes to water in the soaking stage is preferably at least 1:2, preferably at least 1:3, for example 1:4.

The legumes may be soaked for a predetermined time in water prior to the heating step. For example, the legumes may be soaked for at least 6 hours, preferably at least 12 hours, prior to the heating step.

The legumes are preferably soaked at room temperature.

After soaking, the soaked legume mixture is preferably fully drained to remove all liquid and to provide soaked legumes. The liquid is typically cloudy in appearance.

The soaked legumes may be rinsed with cold water. Cold water preferably rinses the soaked legumes until the water being drained from the soaked and rinsed legumes runs clear (i.e. is not cloudly in appearance) to provide soaked and rinsed legumes.

Prior to introducing water for heating to the soaked, and optionally rinsed, legumes, the soaked, and optionally rinsed, legumes are preferably spread out within a cooking vessel such that the legumes are relatively flat. By ensuring that the legumes are provided in a relatively flat manner, it has been found that the method of aquafaba production is more efficient and produces more consistent results.

The soaked, and optionally rinsed, legumes may be placed in any suitable cooking vessel, such as for example an industrial kettle or large container. The size and type of container may vary depending on the particular requirements.

Once water for the heating step is introduced into the cooking vessel containing the soaked, and optionally rinsed, legumes, a lid may be secured in place prior to (or during) heating of the soaked legume-water mixture.

In one embodiment, a lid may be secured in place to provide, in use, a pressurised container. For example, the cooking vessel may be a pressure cooker. The lid may comprise a steam release. In one embodiment, a lid may be secured in place and the steam release may be operable to be placed in a closed position to provide pressurised, heating conditions within the cooking vessel.

In one embodiment, the soaked (and optionally rinsed) legume-water mixture is stirred during the heating step. For example, the cooking vessel may comprise a stirrer operable to stir the legume-water mixture received therein. The stirrer may be operable to stir the mixture continuously during the entire heating step or during one or more intermittent portions thereof. For example, the stirrer may be operable to stir the mixture during a first portion of the heating step.

Preferably, the ratio of soaked and drained legumes, such as for example soaked and drained chickpeas, to water is about 1:1 by weight.

In one embodiment, the method comprises a first heating phase (referred to herein as a pre-cook phase) and a subsequent second heating phase (referred to herein as a cooking phase).

In one embodiment, the legumes are preferably heated during the heating step (for example during the pre-cook phase and cook phase) for at least 2 hours, preferably at least 3 hours, for example about 4 hours.

The duration and heating provided during the first heating phase (the pre-cook phase) is preferably sufficient to raise the temperature of the soaked (and optionally rinsed) legume-water mixture to a predetermined value, preferably to a temperature of 95 degrees. Once the temperature of the soaked (and optionally rinsed) legume-water mixture has reached the predetermined temperature, the first heating phase comes to an end and the second heating phase begins.

During the first heating phase, the soaked (and optionally rinsed) legume-water mixture may be stirred by a stirrer to ensure that the legume-water mixture is evenly heated. The legume-water mixture may be heated for any suitable time period, during the first heating phase, to reach the desired temperature of about 95 degrees. This time period may vary depending on the size of the cooking vessel and the intensity of the heat provided. In one embodiment, the legume-water mixture is preferably heated for at least 5 minutes, preferably at least 10 minutes, preferably at least 30 minutes, preferably about 60 minutes, for example about 70 minutes to reached the desired temperature. Once the desired temperature has been reached during the pre-cook phase, the soaked (and optionally rinsed) legume-water mixture may be pre-cooked at the desired temperature for a further at least 30 minutes, preferably at least 40 minutes, for example at least 50 minutes. On completion of the first heating phase, a heated precooked legume-water mixture is provided.

During the first heating phase, the soaked (and optionally rinsed) legume-water mixture may be stirred. Preferably, the soaked (and optionally rinsed) legume-water mixture is stirred for at least 20 minutes. preferably at least 30 minutes during the first heating phase. Preferably, the stirring continues for a time period of no more than about 50 minutes, preferably no more than 40 minutes. In one embodiment, on completion of the first heating phase, the stirring is stopped (for example the stirrer is switched off). Stirring can help speed up the heating of the soaked (and optionally rinsed) legume-water mixture thereby reducing the duration of the first heating phase. It is however important that stirring does not continue for a time period which causes the break down of protein in the cell wall of the legumes, as this can be detrimental to the stability of the aquafaba. It has been found that stirring should not occur for a time period of more than 60 minutes.

After completion of the first heating phase, the second heating phase begins. During the second heating phase, the pre-cooked legume-water mixture is maintained at a temperature of 95 degrees for a period of at least 2 hours, preferably at least 3 hours, for example 3 hours 10 minutes. In one embodiment, the pre-cooked legume-water mixture is maintained at a temperature of 95 degrees for a period of between 2 hours and 4 hours.

A lid may be placed on the cooking vessel for both the first and second heating phases.

The temperature of the heated precooked legume-water mixture may vary during the cooking phase of between preferably 95 degrees and 100 degrees, for example between 95 degrees and 98 degrees.

During the first heating phase, the cooking vessel may be pressurised.

Preferably, during the second heating phase, the cooking vessel is not pressurised.

On completion of the cooking step or cooking phase, a cooked legume-water mixture is provided. The aquafaba may be obtained by separating the cooked legume-water mixture. The separation phase may take at least 10 minutes, preferably at least 20 minutes, for example about 30 minutes.

The cooked legume-water mixture may provide excess foam on top of the mixture. The excess foam may be removed and discarded from the mixture.

The cooked legume-water mixture, after removal of excess foam, may be acidified using an acid additive.

Acid additive(s) can provide a stiffening agent to enhance the cooked product. In embodiments, the acid additive is apple cider vinegar, lemon juice or cream of tartar. In embodiments, the acid additive is added in an amount of less than 2% or 1.5% or wherein the acid additive is added in an amount of greater than 0.15%.

The cooked legume-water mixture may be drained, and preferably filtered using a filter, for example a sieve, having a predetermined pore size, to obtain aquafaba.

Acid additive(s) may be added to the aquafaba during a whisking step of making meringue, sponge or other baked goods. The acid additive may result in lowering the final pH of the aquafaba, to a pH lower than 6, such as pH 5.5, pH 5.0, pH 4.5, pH 4.0, pH 3.5 or pH 3.0.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

It has been found by the present inventors that ensuring a sufficient minimum of protein and a sufficient minimum content of certain types of polysaccharide in the aquafaba allows for superior egg substitute function in various cooking applications. A maximum content of other types of polysaccharide may also contribute to the egg substitute function of the aquafaba of the invention.

Providing packaged aquafaba separated from legumes having a minimum protein content and combined polysaccharide content ensures a reliable and consistent supply of aquafaba for consumers.

Aquafaba includes solid material, both soluble and insoluble. Of the solid material, approximately one third may be polymeric material, or high molecular weight material (HMWM). HMWM is made up of long chain molecules, such as proteins and polysaccharides, amongst other large molecules that make up cell wall material of the legumes used to make the aquafaba. The inventors have determined that a specific ratio of polysaccharides to protein within the HMWM is critical for achieving an aquafaba with superior foaming qualities and foam stability.

The remaining solid material is low molecular weight material (LMWM, consisting of amino acids, small sugar molecules, such as glucose, salts, saponins etc. which are typically less than 14 kDa in weight.

The term “good foamability” means that the aquafaba aerates well when whipped with a hand or electric whisk, or the like. The aquafaba is capable of holding and retaining air within the whipped structure.

The term “foam stability” means the foam is stable and retains its shape and air content for a reasonable amount of time, for example, at least four minutes or at least five minutes on standing.

The inventors have shown that there are ratios of protein: polysaccharides w/w (weight by weight) of the polymeric material that result in an effective aquafaba. The invention therefore provides packaged aquafaba comprising polysaccharides and protein, wherein the ratio of polysaccharides: protein is 40:60 to 60:40, which includes, but is not limited to ratios of 40:60, 45:55, 50:50, 55:45, 60:40 and values in between.

The polysaccharides included in the aquafaba can be any one or more of rhamnose, fucose, ribose, arabinose, xylose, mannose, galactose and glucose. The polysaccharides comprise mainly arabinose, galactose and glucose as the main component, with rhamnose and xylose present in lower amounts, as well as fucose, ribose and mannose (vestigial amounts). Glucose may be detrimental to the foam quality and stability, and therefore it is preferred that glucose is present in an amount of no more than 50% of the total polysaccharide content, more preferably less than 45%, less than 40%, less than 35%, or less than 30%.

The inventors have found that it is not only the quantity of polysaccharides that is important for a superior aquafaba but also the particular type of polysaccharides. During cooking, protein and polysaccharides are extracted from the chickpeas as a result of the degradation of the legumes' cell wall, which occurs during cooking.

Particular polysaccharides required for foamability and stability may be arabinogalactans (arabinose and galactose) which are both pectic polysaccharides. These are branched polysaccharides having negative charges, which, without being bound by theory, are thought to be important in interacting with the protein in the aquafaba foam and creating stability. The cellulose from chickpea/legume cell walls may also contribute to foamability and stability. Cellulose and other starches may release glucose, which if present in too high an amount, may have negative influence on the aquafaba properties. Therefore, polymeric galactose, and arabinose, rather than glucose are the preferred polysaccharides. Starch/glucose may be present in a maximum amount of 50% of the polysaccharide, preferably less than 50%, 40%, 30%, 20% 10% or 5% or less.

At least 40% of polysaccharides should correspond to arabinogalactans, preferably, 50%, 60%, 70%, 80% 90% or 100%. Arabinogalactans may make up 43% of the total polysaccharides.

The required presence of polysaccharides is surprising given that egg white itself contains virtually no polysaccharides and the protein alone allows egg white to produce a stable foam and be used successfully as a binder in baked goods.

The protein concentration in the aquafaba of the invention may be from 3 g/L to 17 g/L, such as 4, 5, 6, 7, 8, 9, 10, 11, 12, 13, 14, 15, 16 g/L or amounts in between. In particular, the protein content may be from 3.4 g/L to 16.2 g/L, from 4 to 15 g/L, from 5 to 14 g/L, from 6 to 13 g/L, from 7 to 12 g/L, from 8 to 11 g/L or from 9 to 10 g/L. Processing the legumes (e.g. extra cooking) to produce aquafaba with higher protein content can be useful for structural integrity of resulting cooked products but there is a trade-off in terms of cooking times and disintegration of the legumes during cooking. Higher protein content often results in an increase in legume taste in the product, and therefore a content of 20 g/L to 25 g/L is the maximum desired amount of protein in the aquafaba of the invention. Further, such processing can result in higher total mass of compounds in the aquafaba which also often results in an increase in legume taste in the product, and therefore a content of 11.5% total compounds is the maximum desired amount of total compounds in the aquafaba of the invention.

The polysaccharide concentration may be from 1 g/L to 12.5 g/L, such as 2, 3, 4, 5, 6, 7, 8, 9, 10, 11 g/L or any amount in between. In particular the polysaccharide content may be from 1.3 g/L to 11.9 g/L, from 2 to 12 g/L, from 3 to 11 g/L, from 4 to 10 g/L, from 5 to 9 g/L, from 6 to 7 g/L or 6 to 8 g/L. The polysaccharide content may be up to 17 g/L, such as 13 g/L, 14 g/L, 15 g/L or 16 g/L.

Both supernatant and precipitate/sediment of aquafaba comprise soluble solid material and insoluble solid material. The aquafaba may comprise at least 30 g/L total solids. It may comprise 35 g/L, 40 g/L 45 g/L, 50 g/L, 55 g/L, 60 g/L, 65 g/L or 70 g/L total solids. Solids are the parts of the aquafaba that are not water and may be obtained by water or ethanol precipitation. Solids includes soluble and insoluble solids.

High molecular weight material (HMWM) (also known as polymeric material) makes up approximately one third of the solid material, wherein the remaining solid material is low molecular weight material (LMWM). HMWM in aquafaba comprises protein and polysaccharides. The polysaccharides may be pectic polysaccharides. Pectic polysaccharides are negatively charged and interact with protein in the aquafaba to denature and alter the structure of the proteins. The altered structure of the proteins enables retention of air within the whipped aquafaba and therefore produces a good foam with high stability. The negatively charged polysaccharides are important for viscosity, interacting with the positively charged proteins to produce a high-foaming aquafaba. The pH of the aquafaba may be less than or equal to pH 7, pH 6, pH 5, pH 4 or pH 3.5 or pH 3.

The sediment/precipitate comprises starch and cellulose. Whilst previous publications have emphasised the importance of a high starch content for producing an aquafaba of superior quality, the inventors have surprisingly found that starch negatively impacts on the foamability of the aquafaba and the stability of the foam. Therefore, it is desirable to reduce the quantity of starch in the aquafaba. Glucose present in starch is likely to cause the negative effect exhibited by starch on aquafaba foaming and foam stability. Therefore, the total polysaccharides in the aquafaba may comprise less than 50% glucose, as discussed above.

In aquafaba that shows positive results in terms of stable foaming aquafaba the total polysaccharide content may be about 3 g/L to about 5 g/L in the material soluble in water (supernatant, SN), such as 3.8 g/L and about 4.5 g/L to about 6 g/L in the material insoluble (precipitate/residue, PP), such as 5.3 g/L. Polysaccharides may represent about 14% to about 16%, or about 15% weight by weight of the total solid material. Polysaccharides may be up to 20% of the solid material.

The protein content of such aquafaba may be about 5.5 g/L to about 6.5 g/L in the supernatants, such as 6.1 g/L and about 4.5 g/L to about 6 g/L in the precipitates/residue, such as 5.2 g/L. Protein may represent about 18% to about 20%, or about 19% of the total solid material. Protein may represent from 14% of the solid material. It is postulated that proteins are usually required for foaming production, but the polysaccharides are responsible for the foam stability. Such protein content and polysaccharide content values can be achieved by making the aquafaba according to various methods with the presently disclosed goal of controlling the production to achieve such goals (which may involve some manageable trial and error) or the herein described manufacturing methods can be followed and optimized to achieve such values, or a combination of both possibilities can be followed.

The total quantity of solids in aquafaba can be calculated using the following protocol:
1. Weigh an empty tray and record the mass (g);
2. Add 100 mL of aquafaba to the tray and dry it for 12 h in an oven at 105° C.;
3. Weigh the tray with the dry sample and record the mass (g);
4. Calculate the total solids content according to the equation:

$$Total solids content = {weight}_{tray + sample} - {weight}_{tray}$$

The packaging may be provided by sealing (e.g. airtight to preserve freshness) the aquafaba in the packaging. Various packaging sizes are contemplated from end consumer size packaging (e.g. 100 m1 to 1 litre) to industrial packaging (e.g. 5 or 10 or more litres) for use of aquafaba in further manufacturing.

The aquafaba may be liquid aquafaba, e.g. only liquid. That is, the aquafaba preferably does not include whole legume solids/seeds. There may, however, be some sedimentary matter as allowed by pore size of drainer used to separate legume solids from liquid, which is referred to as the solids or solid material, above.

The aquafaba may be packaged in a pouch or carton. The pouch or carton may be a retort pouch or carton to ensure freshness and extend the shelf life. The pouch or carton may be aseptically filled. The package may be for end consumers. The package, such as a barrel or IBC container, may be for further manufacturing use.

The aquafaba comprises water in which legumes have been cooked, wherein the legumes are selected from the group consisting of chickpeas, butter beans, haricot beans, black beans, red kidney beans, cannellini beans, navy beans, mung beans, pinto and combinations thereof. It has been found that these legumes, and not soy beans, are particularly suitable for egg substitute in terms of function without an overpowering bean taste being imparted on the cooked product, which is particularly relevant for sweet end products.

The aquafaba comprises water in which legumes have been cooked, and the legumes may be selected from the group consisting of chickpeas, butter beans and cannellini beans and combinations thereof. Again, these bean types have been found to be provide particularly high performing aquafaba in various cooking applications. Of particular interest is chickpeas or a combination of butter beans and chickpeas for making meringue and cannellini beans for making baked goods (such as sponge-based baked goods).

The aquafaba may comprise water in which a combination of at least two different legumes have been cooked, a first of the legumes being present in a ratio relative to a second of the legumes in any of the ranges 80% to 20%, 70% to 30%, 60% to 40%, 55% to 45% and 50%. In other examples, just one type of legume is used, such as chickpea.

In another aspect, a method of manufacturing aquafaba is provided. The method may include one or more steps of soaking, draining, rinsing then boiling or pressure-cooking legumes in water and removing the legumes to obtain aquafaba, and optionally packaging the aquafaba. In this way, a reliably stable source of aquafaba is provided to consumers, chefs and manufacturers.

In particular, the method of producing aquafaba comprises the steps of:
a) boiling legumes in water increasing the temperature to at least 92° C., wherein the legumes have been soaked and drained;
b) cooking the legumes at a temperature at least 92° C., preferably under pressure for at least 90 minutes, maintaining a temperature between 92° C. and 98° C.; and
c) separating the legumes from the water immediately after cooking to obtain aquafaba.

The method may also include one or more of soaking the legumes in water for at least 8 hours prior to step a); removing the water from the legumes to obtain drained legumes; rinsing the legumes in clean water prior to step b); removing excess scum or foam produced during cooking prior to step c); acidifying the water in which the legumes are heated: packaging the aquafaba obtained from step c); and retorting the packaged aquafaba.

Another method of producing aquafaba comprises the steps of:
d) heating legumes in water increasing the temperature to above 100° C. under pressure, wherein the legumes have been soaked and drained;
e) cooking the legumes at at least 102° C. for at least 45 minutes, maintaining a temperature between 101° C. and 118° C.;
f) separating the legumes from the water within 30 mins of cooking to obtain aquafaba

The pressure cooking, or step a), may be carried out at 100 to 6000 millibar, 150 to 4000 millibar, 150 to 3000 millibar or 150 to 2500 millibar. The pressure in the pressure-cooking step enables the denaturing proteins but does not cause the breaking of such; whilst also ensuring a sufficiently quick cook time. A cook time for the pressure-cooking step of 45 to 120 minutes is preferred, optionally 60 to 90 minutes.

The pressure-cooking step may be performed at be at a temperature of less than 130° C. and more than 100° C. The temperature may be greater than 101° C. and less than 130 or 135° C.

The method may be carried out after obtaining soaked legumes or soaked and drained legumes or soaked and drained and rinsed legumes from another source. The soaking, draining and rinsing may be part of the inventive method. The legumes may be soaked for at least 8 hours, for at least 9 hours, for at least 10 hours, for at least 11 hours or for at least 15 hours.

The boiling may be performed for at least 60 minutes, at least 70 minutes, at least 80 minutes, at least 90 minutes, at least 100 minutes, at least 110 minutes, at least 120 minutes, at least 150 minutes, at least 160 minutes, at least 180 minutes, at least 200 minutes, at least 220 minutes, at least 240 minutes, or thereabouts.

The pressure cooking may be performed for at least 30 minutes, at least 35 minutes, at least 40 minutes, at least 45 minutes, at least 50 minutes, at least 60 minutes, at least 65 minutes, at least 70 minutes, at least 75 minutes, at least 80 minutes, at least 90 minutes, at least 105 minutes, at least 120 minutes, at least 150 minutes or at least 190 minutes, or thereabouts.

Boiling or cooking legumes under pressure allows extraction of protein and polysaccharides from the legumes into the cooking water, each being extracted at different times during of the cooking/boiling process. It is also desirable to reduce processing times such that the pressure cooking is performed for less than (or equal to) 240 minutes, 200 minutes, 160 minutes, 150 minutes, 120 minutes, less than 100 minutes, less than 90 minutes, less than 80 minutes, less than 70 minutes or less than 60 minutes.

The legumes may be selected from the group consisting of chickpeas, butter beans, haricot beans, black beans, red kidney beans, cannellini beans and combinations thereof. The legumes may be selected from the group consisting of chickpeas, butter beans and cannellini beans and combinations thereof. Preferably, the legumes are chickpeas. The legumes may comprise a combination of at least two different legumes, a first of the legumes being present in a ratio relative to a second of the legumes in any of the ranges 80% to 20%, 70% to 30%, 60% to 40%, 55% to 45% and 50%.

The method may include protein analysing and glucose analysis. Due to the complexity of analysing polysaccharides, glucose analysis provides proxy data for the polysaccharide content in the aquafaba. The Brix are analysed in this process, with the content requiring at least 6 brix of glucose but less than 20 Brix.

By including protein and polysaccharide analysis in the manufacturing process, stability of the aquafaba can be ensured. In embodiments, the method includes discarding aquafaba not having a predefined minimum protein content. In embodiments, the predefined minimum protein content is as defined for the aquafaba of the invention. The method may include discarding aquafaba not having a predefined minimum polysaccharide content. The predefined minimum polysaccharide content may be as defined for the aquafaba of the invention.

The weight ratio of legumes to water in the heating step, for example in the pre-cook and/or cooking step, for example in the pressure-cooking step, may be 50% to 50%, 40% to 60%, 30% to 70%. Such ratios have been found to provide relatively high performing aquafaba.

The process may include retorting the aquafaba at above 1 Bar of pressure and at a temperature between 110-180 degrees after pressure cooking and prior to packaging. In other embodiments, a retort step is not used.

The aquafaba described herein can be used to make egg-free baked goods and other egg-free cooking such as pancakes or Yorkshire puddings. In one aspect, the egg-free baked good is provided. The egg-free baked goods may be sponge-based such as muffins and sponge cakes.

The aquafaba described herein can be used to make egg-free meringue. In another aspect, the egg-free meringue is provided. Meringue is another example of a baked good.

The afore-described method may not include a packaging step and the method may continue to use the aquafaba in making egg-free meringue or other baked goods.

Acid additives can provide a stiffening agent to enhance the cooked product. In embodiments, the acid additive is apple cider vinegar, lemon juice or cream of tartar. In embodiments, the acid additive is added in an amount of less than 2% or 1.5% or wherein the acid additive is added in an amount of greater than 0.15%.

The aquafaba may additionally include an acid additive. The method of producing the aquafaba may comprise an additional step of adding the acid additive. Alternatively, the acid may be added to the aquafaba during a whisking step of making meringue, sponge or other baked goods. The acid additive may be added to the cooking water. The acid additive may result in lowering the final pH of the aquafaba, to a pH lower than 6, such as pH 5.5, pH 5.0, pH 4.5, pH 4.0, pH 3.5 or pH 3.0.

A method of producing the aquafaba is shown in FIG. 8. FIG. 8 is a flow chart illustrating a method 100 of manufacturing aquafaba. The method of FIG. 8 is a batch process as an example. In-line processes may be used. The process for boiling vs. pressure cooking is the same, however overall cooking time may vary.

The legumes may be soaked before cooking.

At 102, a pressure-cooking vessel is provided. The pressure-cooking vessel may include an integrated stirrer and a drain function to remove liquids whilst leaving solids in a kettle. The pressure-cooking vessel maintains the kettle in an air-tight and liquid tight condition to minimize water loss. The pressure-cooking vessel operates in the range of pressures 150 to 2500 millibar or 2000 millibar in some examples. One example suitable pressure-cooking vessel is a Firex Cucimax CBT 310A V1, which has a 310-litre kettle.

At 104, legumes and water are added to the kettle of the pressure-cooking vessel. Legumes may be chickpeas, butter beans and cannellini beans and combinations thereof. However, other legumes have been found to be effective as has been described heretofore. The legumes can be dried or soaked. The water content of the legumes (which may or may not be a mix of different types) and water may be in the range of 10% to 25% legumes and 90% to 75% water, by weight. It should be appreciated that for soaked legumes, weight of the water in the beans is to be included in the overall weight of water in the kettle of the pressure-cooking vessel.

Prior to step 104, the legumes (e.g. chickpeas) may be prepared by blanching of the legumes at between 80 to 100 degrees ° C. for up to 30 minutes, or up to 40 minutes. The blanching step may include stirring the legumes. After the blanching step, the legumes are separated from the blanching water (e.g. drained) and provided in the pressure-cooking vessel.

At 106, the legumes and water are pressure cooked. In one example embodiment, pressure cooking is performed at 200 millibar and for 45 to 100 minutes (e.g. about 60 minutes). The water is boiled or simmered, and the pressure-cooking vessel maintains a set pressure. Optimal pressure-cooking conditions for obtaining effective aquafaba include a variety of factors such as the type of legumes and the type of pressure-cooking vessel. Generally, pressure-cooking is performed at a pressure between 0.3 bar and 6 Bar and for 45 to 120 minutes and at a temperature of between 110° C. and 185° C.

At 108, legumes and water are separated. In embodiments, a tilting function of the pressure-cooking vessel is used, and a drain valve is used to separate the water from the legumes. The cooked legumes can be repurposed for other products. The separated water is aquafaba. In some embodiments, the yield of water in to the process 100 to aquafaba out of the process 100, by weight, is between 50% and 80%.

A retorting step may be included in the process after step 108 to maximize product lifetime. The retorting step has a sterilization function. Retorting may be performed on the aquafaba at above 2 Bar of pressure and at a temperature of between 110° C. to 230° C. Retorting may not be used.

At 110, protein content of the aquafaba produced in step 108 is analysed to ensure a sufficient protein content. The optimal protein content depends to some extent on the cooking application for the aquafaba and the type of legumes. Exemplary protein content minimums for chickpeas are, by weight, 11, 12, 13, 14, 15, and 16 g/L Exemplary protein content minimums for butter beans are 8, 9, 10, 11 and 12 g/L. Exemplary protein content minimums for cannellini beans are 22, 23, 24, 25 and 26 g/L. At 110, polysaccharide content of the aquafaba is controlled to ensure a sufficient minimum thereof, according to the minimums described above.

Exemplary parameters for adjusting the process 100 to ensure minimum protein and polysaccharide content are achieved include water content in step 104 and pressure, temperature and cook time in step 106. According to the present disclosure, optimal parameters are established based on trial and error using protein analysis and polysaccharide feedback for a given process and cooking set-up to ensure effective aquafaba is achieved consistently. Once the process has been set up to consistently achieve the minimum protein content and optionally the minimum polysaccharide content, testing of each further batch is not required (although it may be performed periodically to ensure set standards are being maintained).

Step 110 may include testing of each batch of aquafaba (or continuous testing in in-line processes) to ensure the protein content (and optional polysaccharide) goal is achieved and discarding any batches when the minimum protein content is not achieved. However, for suitably optimized processes, all batches may achieve the minimum protein content without requiring batch by batch testing (or continuous testing) and discarding.

At 112, the method 100 may include packaging the aquafaba liquid. Packaging may include filling and sealing a pouch or carton. However, canned and other packaging are envisaged, such as a barrel or other industrial vessel where the aquafaba is to be used in a subsequent manufacturing process rather than being supplied for end consumers. The pouch or carton may be a retort pouch or carton. Retort packages allow freshness of the aquafaba to be maintained without requiring chilling at each stage of the supply chain, extending the shelf life. Filling of the pouch can be performed by hot filling in some examples. Such packaging is suitable for end-consumers and can include 100 ml packages to 1000 ml packages. Where the next user is a manufacturer (e.g. meringue or sponge maker), larger packaging is used such as at least 5 litres. In such embodiments, tubs or barrels are used for packaging and the aquafaba is preserved by keeping the tubs or barrels chilled. In some embodiments. step 112 is not performed and the aquafaba liquid is moved directly onto the next step in a manufacturing process such as making meringue or other baked goods.

In one specific example of method 100, 50 kilograms of dried chickpeas were added to the pressure-cooking vessel in step 104 along with 50 kilograms of water. The beans were cooked for 40 minutes at 200 millibar, resulting in 55 kilograms of cooked chick peas and 45 kilograms of aquafaba.)

FIG. 9 is a flow chart illustrating a method 200 of making egg-free meringue using aquafaba produced as hereinbefore described.

At 202, the aquafaba is whisked until stiff peaks are formed. In embodiments, an electrical whisking or whipping device is used. In one example, the whisking step takes 2 to 4 minutes, 4 to 8 minutes or about 10 minutes. Chickpea based aquafaba or a combination aquafaba of chickpeas and butter beans may be used. Accordingly, at least 30%, 40%, 50%, 60%, 70%, 80%, 90% or 100% of the legumes, by weight, used in method 100 are chickpeas with the balance (if any) being butter beans to produce aquafaba for method 200 that has been found to result in comparable consistency and flavour meringues to those using egg whites. This type of aquafaba is merely by way of example. For example, cannellini beans (alone or in combination with other legumes seeds) could be used. 100% butter beans aquafaba has also been found to produce effective egg-free meringue.

In some embodiments, an acid additive is added at step 202 as a stiffening agent. Exemplary acid additives include cream of tartar and apple cider vinegar, lemon juice, amongst others. The acid additive may be added in an amount of less than 2% or 1.5% and the acid additive is added in an amount of greater than 0.15% relative to, by weight, the other meringue ingredients (sugar and aquafaba).

At 204, sugar is gradually added to the aquafaba and whisked (e.g. whisking of step 202 is continued). Sugar may form at least 50%, by weight, of the meringue ingredients and up to 70%, with about 60% sugar and about 40% aquafaba being used in one example. Whisking continues until a suitable meringue consistency is obtained. Whisking can take place for at least 5 minutes and up to 50 minutes and at least 20 minutes and up to 40 minutes.

At 206, the meringue mixture from 204 is deposited onto a baking tray. Depositing can be through a piping bag in low quantity applications or using an electrical depositor for larger scale applications. The baking tray can be plain or include forms for each meringue.

At 208, the deposited meringues from step 206 are baked until ready. A fan assisted oven may be used at a temperature from 70° C. to 150° C., particularly about 100° C. It has been found that high quality meringues are obtained using cooking times of from 40 minutes to 120 minutes, particularly 50 minutes to 100 minutes and more particularly 55 minutes to 95 minutes.

At 210, the meringues from step 208 are allowed to slowly cool. The meringues may remain in the oven during cooling with the oven switched off.

At 220, the baked and cooled meringues are packaged suitably, e.g. for sale to end consumers. Aquafaba described herein is useful for making egg-free baked goods such as sponges, muffins, pastry, Yorkshire pudding, meringues and non-baked goods such as mousse or dairy-free butter. The aquafaba is first whipped until stiff peaks form, optionally with addition of acid as described hereinbefore, before adding the whipped aquafaba to other sponge ingredients for mixing.

FIG. 10 is a flowchart of a further embodiment of the present invention. The legumes are soaked and drained prior to heating in water 302. The legumes are preferably soaked in cold water prior to heating in water. The ratio of water to legumes in the soaking stage is preferably at least 1:2, preferably at least 1:3, for example 1:4. The legumes may be soaked for a predetermined time in water prior to the heating step. For example, the legumes may be soaked for at least 6 hours, preferably at least 12 hours, prior to the heating step. The legumes are preferably soaked at room temperature.

After soaking, the soaked legume mixture is fully drained 304 to remove all liquid and to provide soaked legumes. The soaked legumes may be rinsed with cold water until the water being drained from the soaked and rinsed legumes runs clear (i.e. is not cloudly in appearance) to provide soaked and rinsed legumes.

The soaked, and optionally rinsed, legumes are then placed in a suitable cooking vessel. Water is introduced into the cooking vessel and the soaked (and optionally rinsed) legume-water mixture is heated, during the pre-cook phase, to reach a temperature of about 95 degrees 306. The mixture is stirred by a stirrer to ensure that the legume-water mixture is evenly heated. Once the desired temperature has been reached during the pre-cook phase, the soaked (and optionally rinsed) legume-water mixture may be pre-cooked at the desired temperature for a further at least 30 minutes, preferably at least 40 minutes, for example at least 50 minutes.

After completion of the first heating phase (the pre-cook phase), the second heating phase begins. During the second heating phase 308, the pre-cooked legume-water mixture is maintained at a temperature of 95 degrees for a period of at least 2 hours, preferably at least 3 hours, for example 3.10 hours.

On completion of the cooking step or cooking phase 308, a cooked legume-water mixture is provided. Excess foam is removed and discarded from the mixture 310.

Aquafaba may be separated from the mixture 312. The cooked legume-water mixture may be drained, and preferably filtered using a filter, for example a sieve, having a predetermined pore size, to obtain aquafaba.

While at least one exemplary aspect has been presented in the foregoing detailed description of the invention, it should be appreciated that a vast number of variations exist. It should also be appreciated that the exemplary aspect or exemplary aspects are only examples, and are not intended to limit the scope, applicability, or configuration of the invention in any way. Rather, the foregoing detailed description will provide those skilled in the art with a convenient road map for implementing an exemplary aspect of the invention. It being understood that various changes may be made in the function and arrangement of elements described in an exemplary aspect without departing from the scope of the invention as set forth in the appended claims.

### BRIEF DESCRIPTION OF THE DRAWINGS

The present invention will hereinafter be described in conjunction with the following drawing figures, wherein like numerals denote like elements, and the non-limiting examples.

FIG. 1 is a chart showing the concentration of solids in five samples of the claimed aquafaba. The horizontal line denotes the minimum concentration of solids required to produce an aquafaba with good foaming properties.

FIG. 2A is a chart showing the carbohydrate content of five samples of the claimed aquafaba.

FIG. 2B is a chart showing the sugar composition content of five samples of the claimed aquafaba.

FIG. 3 is a chart showing the composition of high molecular weight material (HMWM) of five aquafaba samples. The horizontal line denotes the minimum concentration of solids required to produce an aquafaba with good foaming properties. FIG. 3 also shows a breakdown of the precipitate and supernatant carbohydrate content of each tested aquafaba sample.

FIG. 4 is a chart showing the composition of high molecular weight material (HMWM) of five aquafaba samples. The horizontal line denotes the minimum concentration of solids required to produce an aquafaba with good foaming properties. FIG. 4 also shows a breakdown of the precipitate and supernatant sugar composition of each tested aquafaba sample.

FIG. 5 shows the foaming results from five aquafaba samples. Each sample foamed to stiff peaks in less than 4 minutes on high speed with both hand-held whisk and free-standing kitchen whisk machine. The foam shown in the figures was maintained for over 5 minutes and did not break down. It can be seen from the Figures that all five aquafaba samples with the claimed polysaccharide and protein content produce a good, stable foam.

FIG. 6 shows a variety of meringues made using aquafaba of the invention obtained from various different legumes.

FIG. 7 shows a variety of sponge cakes made using aquafaba of the invention obtained from various different legumes.

FIG. 8 is a flow chart of one method of producing aquafaba.

FIG. 9 is a flow chart of one method of making meringue.

FIG. 10 is a flow chart of one method of producing aquafaba.

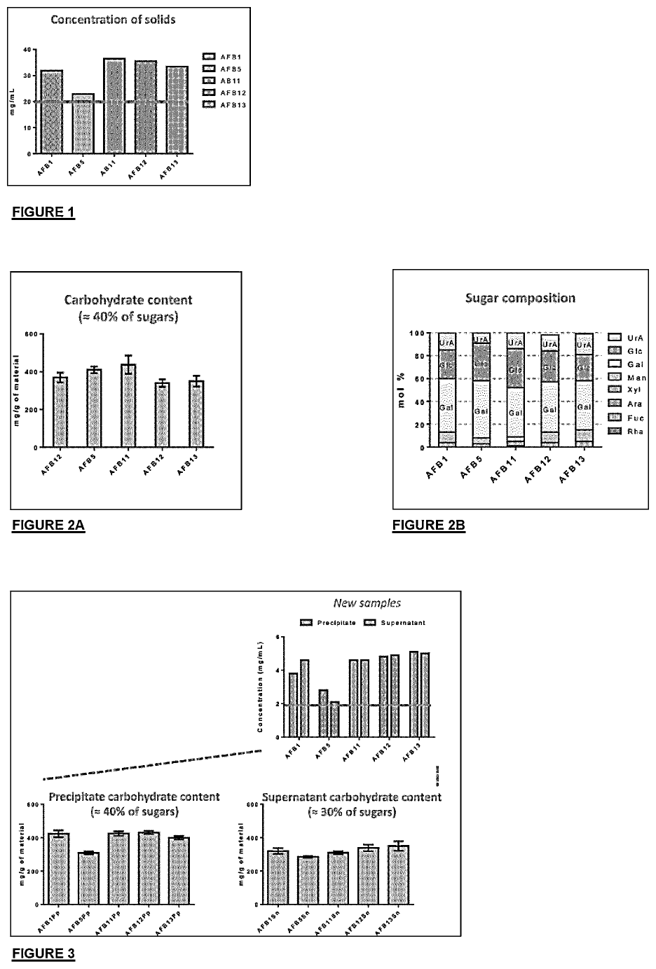

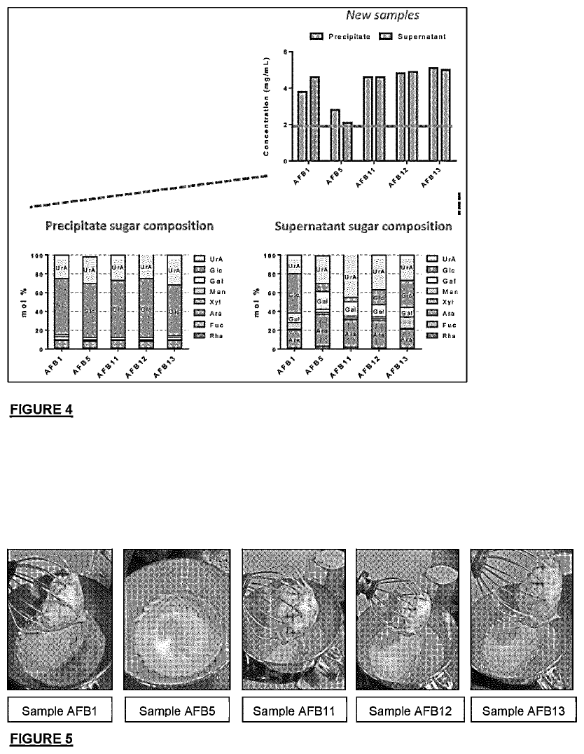

### EXAMPLES

### Example 1

Various chickpea aquafaba samples were analysed and tested for foaming.

It was found that an aquafaba with a protein: polysaccharide ratio of close to 1, such as 50:50 or with variation from 40:60 to 60:40 performed the best at foaming and stability.

It was also found that aquafaba samples with high glucose content did not perform as well as those with a lower glucose content.

It was found that those with at least 40% of the total polysaccharide content of arabinose and galactose performed better than those with a lower level of arabinose and galactose.

It was found that at least 20 g/L solid content was required for good foaming and stability with samples having 60 g/L solid content performing well.

### Example 2

Aquafaba of the invention was prepared according to methods of the invention using different legumes to produce the aquafaba. The legumes used included chickpeas, butter beans, cannellini beans, haricot beans, red kidney beans and black beans. A combination of legumes was also tested. Each aquafaba was then used to make meringues and sponge cakes according to the following recipes:

Meringues: 160 g aquafaba, 240 g sugar, 0.75 g cream of tartar

Sponge cake: 400 g self-raising flour, 240 g caster sugar, 2 teaspoons baking powder, 310 ml soya milk, 160 ml rapeseed oil, 2 tablespoons vanilla essence, 90 ml aquafaba, 5 ml apple cider vinegar.

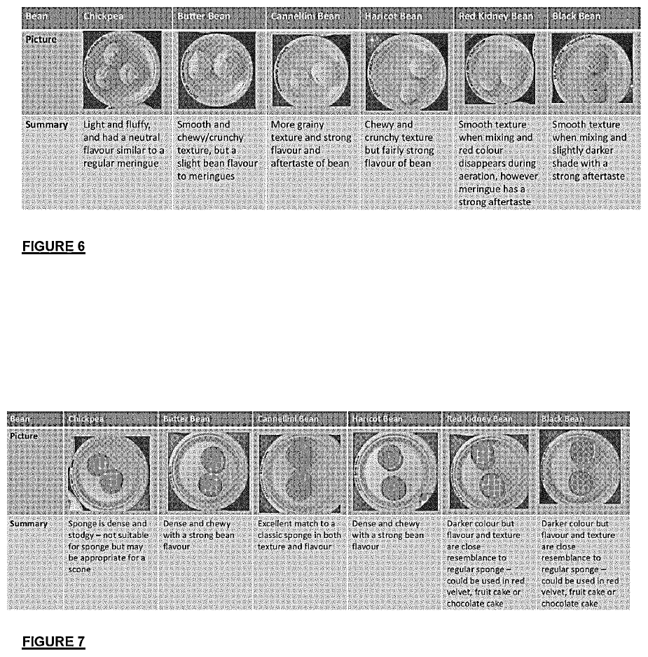

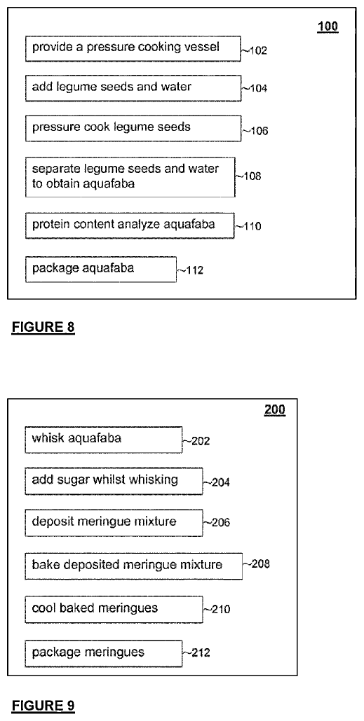

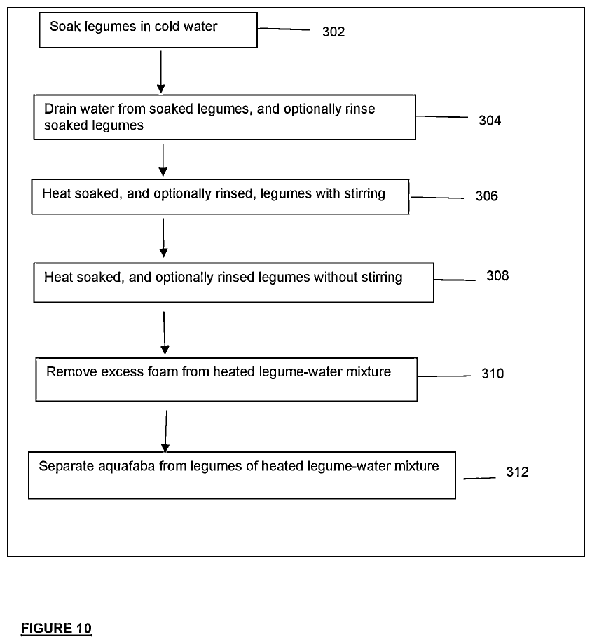

Each aquafaba made according to the invention successfully produced meringues and sponge cakes of a good quality, similar to meringues and cakes made using traditional eggs. Aquafabas made using a combination of legumes also produced meringues and sponge cakes of a good quality. Results are shown in FIGS. 6 and 7. Aquafabas made according to the invention using alternative legumes are expected to produce similar results.

### Example 3

A variety of tests and recipes were carried out to evaluate the performance of aquafaba of the invention in relation to other existing egg white alternatives, canned chickpea water and egg whites.

Test 1—whipping raw variant (PART A) and measuring time taken for whipped foam to break down (PART B)

Test 2—baking meringues using whipped variant to test stability and structure

Test 3—baking cookies using whipped variant to test binding

Test 4—baking muffins using whipped variant to test rising

Test 5—making mayonnaise to test emulsification

Result of each test graded by its success, ranked from 1^{st}-5^{th}. These results will then be collated to determine the best performer.

The egg acted as a control variable to draw comparisons from, as each substitute seeks to replicate its performance capacities. Each recipe used the same ingredients and equipment to ensure each variable was tested in a controlled environment.

“SOFT PEAKS”: when the variable starts to leave a trail and holds structure when gathered with a spoon. Should be much paler by this point but still slightly yellow.

“STIFF PEAKS”: When the variable is so stiff, it doesn't shift in the bowl when agitated. One is able to turn a bowl upside down without the mixture moving at all. Should be white and glossy and shouldn't make a crackle noise when lifted to your ear.

| Variable | Form | Ingredients |
|---|---|---|
| Egg whites | Liquid | Egg whites |
| Aquafaba of | Liquid | Aquafaba (100%) |
| the | | (water, chickpea |
| invention | | extract) |
| (OGGS) | | |
| Canned | Liquid | Aquafaba (100%) |
| chickpea | | (water, chickpea |
| water | | extract) |
| Powdered | Powder | Chickpea Flour, Maize Flour, |
| egg white | | Stabilisers (Vegetable Gum: |
| alternative 1 | | Methylcellulose), Vegetable Protein, |
| (Orgran) | | Dextrose from Maize, Salt, Turmeric, |
| | | Raising Agent (Calcium |
| | | Carbonate), Garlic Powder. |
| Powdered | Powder | Potato flour, tapioca flour, cream of |
| egg white | | tartar, xanthan gum, methylcellulose. |
| alternative 2 | | |
| (Free and | | |
| Easy) | | |

### Test 1

Whisking capacity was tested and the capability to hold a stiff, whisked structure.

Whisking, volume growth and stability was tested according to the following method:
1. Whisk 100 ml variable to soft and stiff peaks from raw form, timing how long It takes to form stiff peaks
2. Measured volume of growth in centimetres from the centre of the bowl upwards
3. Transfer 50 ml of stiff peak whipped variable into a glass
4. Measure decrease in height at 5-minute and 20-minute intervals

### Test 2—Meringue: Testing Structure And Stability

Objective: To see which variable best holds a structure. Successful meringue should keep the same solid structure and shape once cooked. It should be slightly glossy, hard all the way through and peel off the baking paper with ease (no large holes at the bottom).

Ingredients:
100 ml aquafaba of the invention/100 ml egg whites/100 ml canned chickpea water/100 ml powdered egg white alternative 2/100 ml powdered egg white alternative 2
110 g caster sugar
¼ tsp cream of tartar

Method
1. Preheat oven to 100° C./gas mark 1.5 and line 2 baking trays with parchment paper.
2. Start whisking variable, starting on a high speed and whisk until soft peaks form.
3. Add the cream of tartar and continue whisking on the highest speed until stiff peaks form.
4. One tablespoon at a time, slowly add the sugar and continue mixing, until all the sugar is gone.
5. Pipe or dollop the meringue onto the prepared baking trays and pop in the oven for 1.5 hours.
6. After the 1.5 hours is up, turn off the oven and leave the meringues in there to dry for at least another hour.

### Part 3—Cookies: Testing Binding Capabilities

Objective: To see how well the variable works in binding ingredients together. The ingredients should not separate or make the cookie too stodgy. This will therefore be judged on how successfully the cookie spreads out into an even round circle, and how tall the cookie is. It should not exceed 1 cm.

Ingredients:
55 g vegetable fat
30 g caster sugar
30 g soft brown sugar
50 ml aquafaba of the invention/100 ml egg whites/100 ml canned chickpea water/100 ml egg white alternative 1/100 ml egg white alternative 2
½ tsp vanilla extract
90 g plain flour
½ tsp bicarbonate soda
½ tsp baking powder
50 g chocolate chips

Method:
1. Preheat the oven to 180° C. (160° C. if using a fan oven)/gas mark 4 and line a baking tray with parchment paper.
2. Using an electric whisk, cream together the margarine and both types of sugar until the grains dissolve and the mixture becomes paler.
3. Whilst continuing to whisk the margarine and sugar, pour in the variable and the remaining ingredients, other than the chocolate chips and continue whisking on a medium speed.
4. Add the dark chocolate chips into the mixture and stir thoroughly with a spatula.
5. Pop in the fridge for 30 minutes.
6. Using two teaspoons, gather 35 g of dough and roll them into little balls. Spread them out on a baking tray, about 6 per tray as they tend to spread out a lot.
7. Bake for 10-12 minutes. In this time, they should have turned golden, whilst retaining that crucial gooey centre.

Comparative photo of final cookies:

Top left: canned chickpea water, top right: egg white alternative 1, bottom left: egg whites, bottom right: aquafaba of the invention

### Test 4—Muffins: Testing Rising Capabilities

Objective: To see how well the variables work in making the muffins rise. The muffins should have their characteristic dome top and have risen well. They should come out of their cases well.

Ingredients:
130 g plain flour
50 g sugar
½ tsp baking powder
90 ml milk
60 g margarine
50 ml aquafaba of the invention/egg whites/powdered egg alternative 1/powdered egg alternative 2

Method:
1. Preheat oven to 180° C./gas mark 4 (140° C. if using a fan oven) and line your muffin tin with muffin cases.
2. Combine the Margarine and sugar with an electric whisk
3. Add the variable and continue whisking on a medium speed
4. Add the flour and baking powder to the mixture thirds, alongside the milk, folding ever so gently.
5. Distribute 150 g of the batter evenly into each muffin case.
6. Pop them into the oven for roughly 25-30 minutes on a middle shelf.
7. Leave to cool for 10 minutes before moving.

### Test 5—Mayonnaise: Testing Emulsifying Capabilities

Objective: to see how well the variables emulsify. Successful mayonnaise should be thick, white and taste creamy. It should be relatively solid and have a slight wobble.

Ingredients:
50 ml aquafaba of the invention/50 ml egg whites/50 ml canned chickpea water/50 ml powdered egg white alternative 1/50 ml powdered egg white alternative 2
1 tbsp white wine vinegar
½ tsp caster sugar
200 ml vegetable oil
salt and pepper (to your taste)

Method:
1. Using a hand blender, whisk up your variable in a measuring jug, until it's pale, thick and frothy.
2. Add the white wine vinegar and the sugar and whisk again to combine everything fully.
3. Over the next couple of minutes, pour in the oil, very slowly (stream the width of a piece of spaghetti) and continue whisking.

### CONCLUSION

| 1^{st} | 2^{nd} | 3^{rd} | 4^{th} | 5^{th} |
|---|---|---|---|---|
| 54/60 | 49/60 | 32/60 | 14/60 | 10/60 |
| Egg whites | Aquafaba | Canned | Powdered | Powdered |
| | of the | chickpea | egg white | egg white |
| | invention | water | alternative 1 | alternative 2 |

The highest performing variable was the egg, which was also the control in all the recipes tested. Therefore, the highest performing alternative, was the aquafaba of the invention, performing most similar to egg white in each recipe/whisk test.

It's important to note that whilst the can of chickpea water performed well on some tests, it didn't in not others. This is because each can differ from one another and therefore is an unreliable ingredient to cook/bake with in the first place. For example, one tin made a great mayonnaise, and another made a disastrous cookie, proving the differences between each can, whereas the aquafaba of the invention performed consistently across all tests

The powdered substitutes were noticeably very different to an egg, in its form and capabilities. It lacked the naturalness and ease of aquafaba, as you have to rethink recipes according to the product, rather than making direct swaps. It was very hard to find recipes directing you how to use these products.

The aquafaba of the invention constantly replicated and even sometimes, out-performed the control. The aquafaba of the invention is a superior egg alternative.

### Example 4

Three 25 kg bags of chickpeas are opened and placed in cold water within a cooking vessel, such as a kettle or in a large container. The cooking vessel contains cold water to chickpeas in a ratio of approximately 1:4. A lid is placed on the cooking vessel and the chickpeas are soaked overnight for approximately 12 hours. In one embodiment, the chickpeas are rinsed prior to soaking.

The soaked chickpeas are then drained and the liquid is discarded. The chickpeas are then rinsed with cold water until the removed water is clear and colourless in appearance.

The chickpeas are then flattened out within the cooking vessel to ensure an even distribution. 150 litres of water is then added to the cooking vessel. The lid is closed and the steam release is placed in the close position.

The pre-cooking phase is initiated and the filament is set to 180 degrees and the water is heated to 95 degrees with the stirrer on.

After 40 minutes, the stirrer is turned off, the lid is opened and the chickpeas are checked to ensure all chickpeas are covered with the water.

Once water temperature reaches 95 degrees, the cooking phase is initiated and the mixture is cooked for 3 hours 10 minutes.

After the cooking phase is complete, the excess foam on the top of the mixture is removed and discarded.

The mixture is then drained into dilly. A fine strainer is used to drain the aquafaba from the mixture. The aquafaba is collected into 10 kg buckets, the yield is recorded and the aquafaba is frozen.

What is claimed is:

1. A packaged aquafaba comprising polysaccharides and protein, wherein the ratio of polysaccharides: protein is 40:60 to 60:40, and wherein the polysaccharides comprise at least 40% arabinose, galactose or a combination thereof.

2. The packaged aquafaba according to claim 1, wherein the polysaccharides comprise no more than 50% glucose.

3. The packaged aquafaba according to claim 1, wherein the polysaccharides comprise no more than 40% glucose.

4. The packaged aquafaba according to claim 1, wherein the polysaccharides comprise no more than 30% glucose.

5. The packaged aquafaba according to claim 1, wherein a protein concentration is from 12.5 g/L to 30 g/L.

6. The packaged aquafaba according to claim 1, wherein a polysaccharide concentration is from 12.5 g/L to 30 g/L.

7. The packaged aquafaba according to claim 1, wherein the aquafaba comprises at least 20 g/L concentration of total solids, or minimum 6%.

8. The packaged aquafaba according to claim 1, wherein aquafaba has a pH of less than pH 6.

9. The packaged aquafaba according to claim 1, wherein the aquafaba is made from chickpeas, butter beans, haricot beans, black beans, red kidney beans, cannellini beans, navy beans, mung beans, pinto beans, and/or combinations thereof.

10. (canceled)

11. A method of producing aquafaba comprising polysaccharides and protein, wherein the ratio of polysaccharides: protein is 40:60 to 60:40, and wherein the polysaccharides comprise at least 40% arabinose, galactose or a combination thereof, wherein the method comprises:
a) heating legumes in water increasing the temperature to at least 95° C., wherein the legumes have been soaked and drained;
b) cooking the legumes at least 95° C. for at least 1 hr 30 minutes, maintaining a temperature between 92° C. and 98° C.; and
c) separating the legumes from the water within 30 mins of cooking to obtain aquafaba.

12. A method of producing aquafaba comprising polysaccharides and protein, wherein the ratio of polysaccharides: protein is 40:60 to 60:40, and wherein the polysaccharides comprise at least 40% arabinose, galactose or a combination thereof, wherein the method comprises:
a) heating legumes in water increasing the temperature to above 100° C., wherein the legumes have been soaked and drained;
b) cooking the legumes at at least 102° C. for at least 45 minutes, maintaining a temperature between 101° C. and 110° C.; and
c) separating the legumes from the water within 30 mins of cooking to obtain aquafaba.

13. The method as claimed in claim 11, in which the ratio of water to legumes is at least 1:4.

14. The method of claim 11, wherein step a) is carried out at 100 to 6000 millibar, 150 to 4000 millibar, 150 to 3000 millibar, or 150 to 2500 millibar.

15. The method of claim 11, wherein in step a) the legumes are stirred.

16. The method of claim 11, comprising soaking the legumes in water for at least 8 hours prior to step a).

17. The method of claim 16, comprising removing the water from the legumes to obtain drained legumes.

18. (canceled)

19. The method of claim 11, comprising acidifying the water in which the legumes are heated.

20. (canceled)

21. The method of claim 11, comprising:
packaging the aquafaba obtained from step c); and
retorting or aseptically filling the packaged aquafaba.

22. The method of claim 11, wherein step b) is carried out for less than or equal to 190 minutes, 150 minutes, 120 minutes, 105 minutes, 90 minutes, 75 minutes, 70 minutes, 65 minutes, 60 minutes, 55 minutes, 50 minutes, 45 minutes, 40 minutes, 35 minutes, or 30 minutes.

23. The method of claim 11, wherein the legumes are selected from chickpeas, butter beans, haricot beans, black beans, red kidney beans, cannellini beans, navy beans, mung beans, pinto beans, and/or combinations thereof.
